(19) United States
(12) Patent Application Publication
(10) Pub. No.: US 2006/0184415 A1
(43) Pub. Date: Aug. 17, 2006

(54) Business statistical analysis reporting module and method for client application systems

(76) Inventor: Darrell S. Cleavenger, El Paso, TX (US)

Correspondence Address: GARDERE/EDS;GARDERE WYNNE SEWELL INTELLECTUAL PROPERTY, 3000 THANKSGIVING TOWER, 1601 ELM STREET, DALLAS, TX, 75201-4761, US

(21) Appl. No.: 11/058,067

(22) Filed: Feb. 15, 2005

(51) Int. Cl. G07G 1/00

(52) U.S. Cl. 705/10

(57) ABSTRACT

A method, system, and computer program product for collecting data for business statistical analysis from an information technology provided solution is provided. In one exemplary embodiment, business critical processes are determined and from the identities of these business critical processes, business critical collection points are determined. The business critical processes are monitored and data is collected at the business critical collection points. This data is stored for later use by a business statistical analysis system, such as, for example, a Six Sigma Analysis system.

### BACKGROUND OF THE INVENTION

1. Technical Field

The present invention relates to computer software and, information technology process and systems monitoring and management.

2. Description of Related Art

Six Sigma is a term used by many organizations that simply means a measure of quality. Basically, Six Sigma is a disciplined, data driven approach and methodology for eliminating defects in any process—from manufacturing to transactional and from product to service. The method drives towards six standard deviations (standard deviation is also referred to as sigma) between the mean and the nearest specification limit in any process, hence the name “Six Sigma”.

The statistical representation of Six Sigma describes, quantitatively, how a process is performing. To achieve Six Sigma, a process must not produce more than 3.4 defects per million opportunities. A Six Sigma defect is defined as anything outside of customer specifications. A Six Sigma opportunity is then the total quantity of chances for a defect. Process sigma can easily be calculated using a Six Sigma calculator which is well known in the art.

The fundamental objective of the Six Sigma methodology is the implementation of a measurement-based strategy that focuses on process improvement and variation reduction through the application of Six Sigma improvement projects.

Six Sigma analysis may be performed on the systems and solutions created by Information Technology (IT) and Information Service (IS) providers. Typically, an enterprise may retain an IT or IS provider to provide solutions to IT and/or IS problems within the enterprise. The enterprise will then retain another firm to perform Six Sigma Analysis on the systems implemented by the IT or IS provider. Although it would be desirable to have Six Sigma Analysis automatically performed by the system implemented by the IT or IS provider as part of the solution package, currently there is no mechanism for doing so. Therefore, it would be desirable to have a method, system, and computer program product for automatically extracting relevant data from a solution package created by an IT or IS provider and performing Six Sigma Analysis on the system using the extracted data.

### SUMMARY OF THE INVENTION

The present invention provides a method, system, and computer program product for collecting data for business statistical analysis from an information technology provided solution. In one exemplary embodiment, business critical processes are determined and from the identities of these business critical processes, business critical collection points are determined. The business critical processes are monitored and data is collected at the business critical collection points. This data is stored for later use by a business statistical analysis system, such as, for example, a Six Sigma Analysis system.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server in accordance with the present invention;

FIG. 3 depicts a block diagram of a data processing system in which the present invention may be implemented;

FIG. 4 depicts a diagram illustrating an exemplary process flow and program function for integrating a Six Sigma processing system into an IT solution in accordance with one embodiment of the present invention;

FIG. 5 depicts a block diagram illustrating an exemplary payroll system which may be developed by an IT provider and implemented on behalf of an enterprise in accordance with one embodiment of the present invention;

FIG. 6 depicts a schematic diagram illustrating an exemplary system for collecting critical data and transferring this data to a Six Sigma database in accordance with one embodiment of the present invention; and

FIGS. 7 and 8 depict examples of output generated by a Six Sigma analysis in accordance with one embodiment of the present invention.

### DETAILED DESCRIPTION OF THE PREFERRED EMBODIMENT

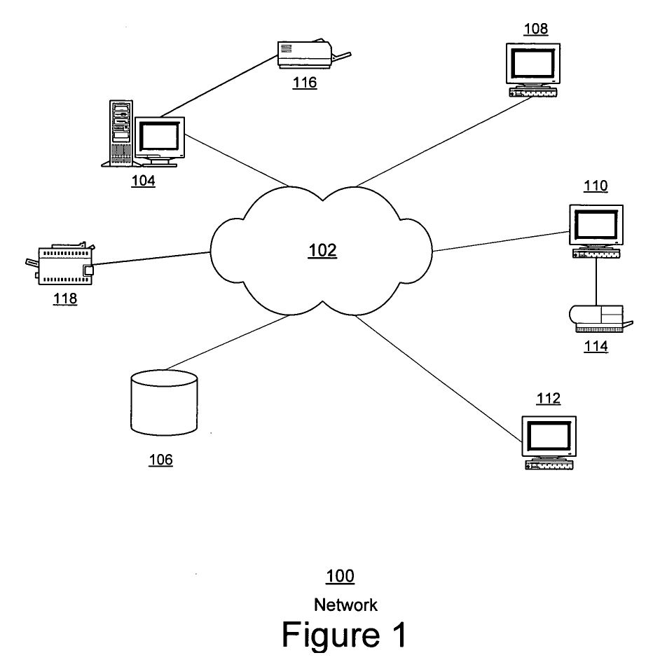

With reference now to the figures, and in particular with reference to FIG. 1, a pictorial representation of a distributed data processing system is depicted in which the present invention may be implemented.

Distributed data processing system 100 is a network of computers in which the present invention may be implemented. Distributed data processing system 100 may be a system developed by an Information Technology (IT) or Information Services (IS) provider for a client or may simply be a system on which the processes and solutions developed by the IT or IS provider are implemented. However, in any event, data processing system 100 is presented merely as an example of a distributed data processing system in which the present invention may be implemented and is not intended as an architectural limitation or as a limitation as to what components, software, or processes are necessary to practice the present invention. Those well skilled in the art will recognize many modifications, changes, and additions to the present exemplary architecture as well as wholly different systems in which the teachings of the present invention may be implemented and practiced.

Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to network 102, along with storage unit 106. In addition, clients 108, 110 and 112 are also connected to network 102. These clients, 108, 110 and 112, may be, for example, personal computers or network computers. For purposes of this application, a network computer is any computer coupled to a network that receives a program or other application from another computer coupled to the network. In the depicted example, server 104 provides data, such as boot files, operating system images and applications, to clients 108-112. Clients 108, 110 and 112 are clients to server 104. Distributed data processing system 100 may include additional servers, clients, and other devices not shown. Distributed data processing system 100 also includes printers 114, 116 and 118. A client, such as client 110, may print directly to printer 114. Clients such as client 108 and client 112 do not have directly attached printers. These clients may print to printer 116, which is attached to server 104, or to printer 118, which is a network printer that does not require connection to a computer for printing documents. Client 110, alternatively, may print to printer 116 or printer 118, depending on the printer type and the document requirements.

In some embodiments, an IT solution to a particular problem may be implemented on distributed data processing system 100. For example, an enterprises payroll system may be developed by an IT provider and implemented on distributed data processing system 100. Other possible solutions that may be implemented by an IT provider include billing systems, accounting systems, and web hosting systems. However, these examples are provided merely as an aid to understanding the present invention and not as limitations. Those skilled in the art will recognize that the potential range of solutions provided by an IT provider for an enterprise are virtually limitless.

In the depicted example, distributed data processing system 100 is an Intranet, with network 102 representing an enterprise collection of networks and gateways that use, for example, the TCP/IP suite of protocols to communicate with one another. At the heart of this Intranet is a backbone of high-speed data communication lines between major nodes or host computers consisting of numerous computer systems that route data and messages. Of course, distributed data processing system 100 also may be implemented as a number of different types of networks such as, for example, the Internet, a Local Area Network (LAN), or a Wide Area Network (WAN).

As noted above, FIG. 1 is intended as an example and not as an architectural limitation for the processes of the present invention.

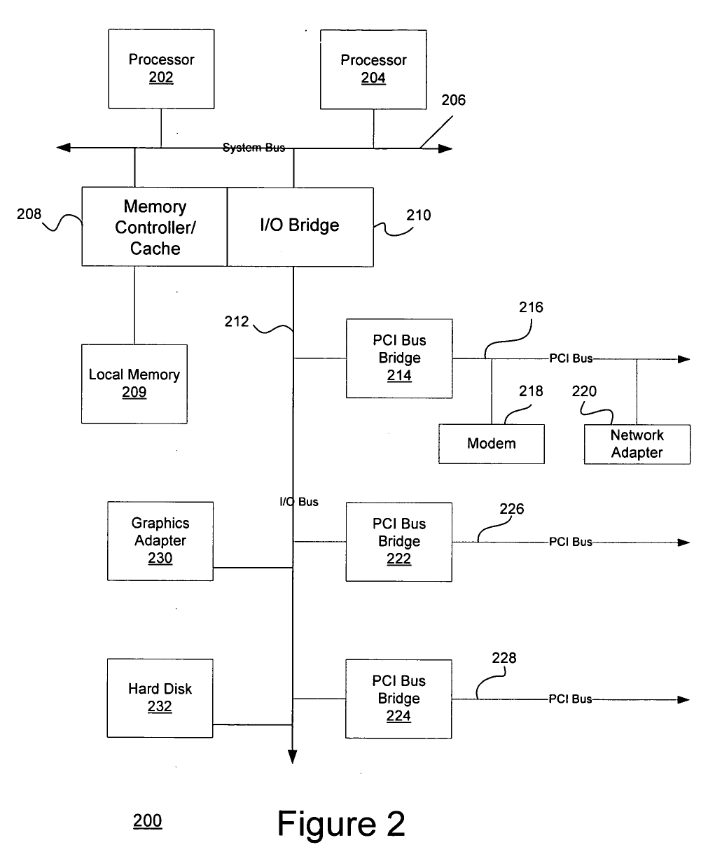

Referring to FIG. 2, a block diagram of a data processing system which may be implemented as a server, such as server 104 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

Data processing system 200 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries.

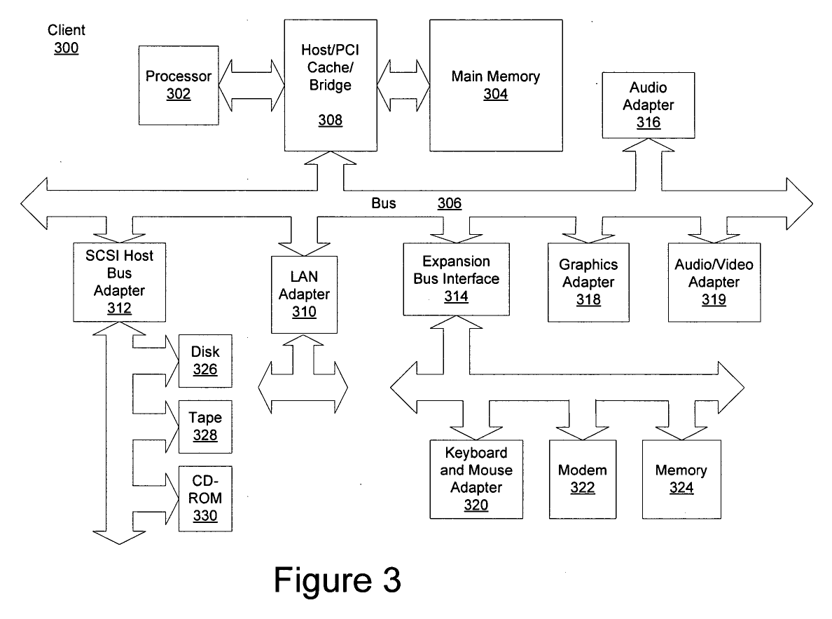

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

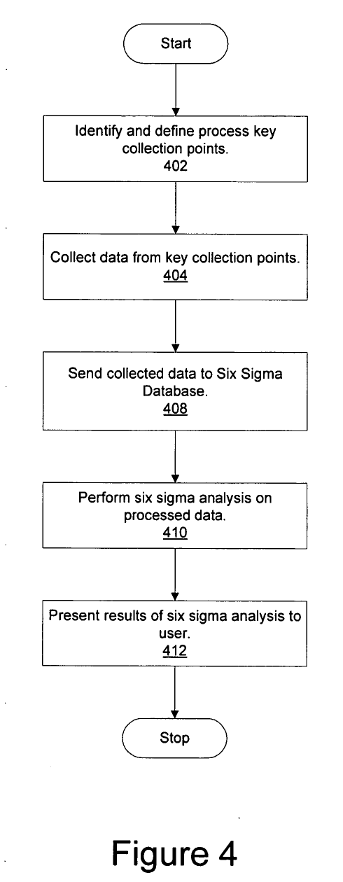

With reference now to FIG. 4, a diagram illustrating an exemplary process flow and program function for integrating a Six Sigma or other business statistical analysis processing system into an IT solution is depicted in accordance with one embodiment of the present invention. To begin, an IT provider works with its client to identify process key collection points and defines these collection points for the system (step 402). The system created by and/or implemented by the IT provider monitors events within the system and collects data from the key collection points (step 404). The collected data from the process key collection points is sent to the Six Sigma database (step 406) and Six Sigma analysis is performed on the data using Six Sigma analysis tools (step 408). It may be necessary to insert software code to key application data, programs or screen collection points in order to collect and send data to be analyzed to the repository in order to manage and control client business process variation. Many Six Sigma analysis tools, as well as other business statistical analysis tools, are available from various vendors and are well known to those skilled in the art.

The results of the Six Sigma analysis or other business statistical analysis are presented to a user in one or more formats as determined by the user and the particular implementation (step 410). The results may be presented in the form of charts and graphs or other formats suitable for conveying the information contained in the results of the Six Sigma Analysis. Thus, the present invention helps a business enterprise to maintain visibility of their entire functional business process by collecting the data at key collection points and performing statistical analysis to track process variation.

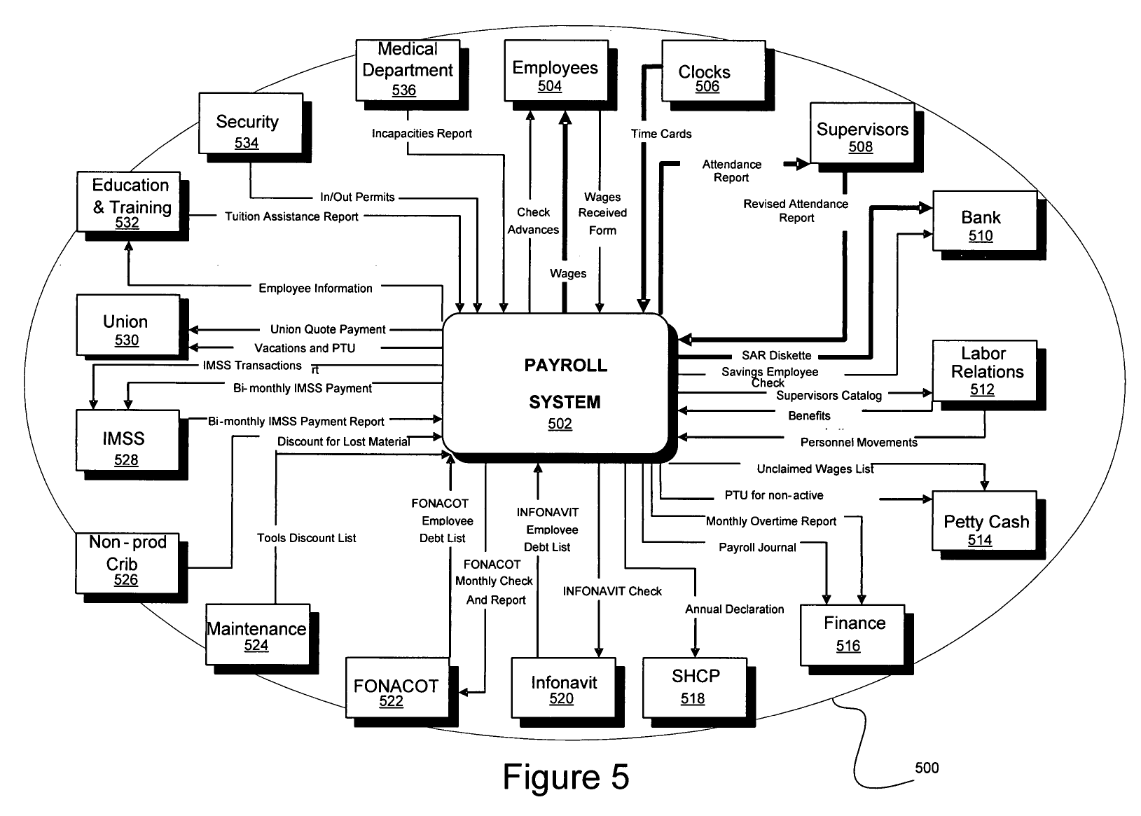

To aid in understanding the present invention, consider the following example. Referring now to FIG. 5, a block diagram illustrating an exemplary payroll system which may be developed by an IT provider and implemented on behalf of an enterprise is depicted in accordance with one embodiment of the present invention. The payroll system 502 works in conjunction with and interacts with other systems and components 504-536 within the enterprise system 500 in order to perform its function correctly. These interactions involve processes and transfers of data between various entities and components 504-546 and the payroll system 502 as indicated by the lines and arrows depicted in FIG. 5. However, because these components and systems 502-536 and processes are typically implemented by an IT provider, the IT provider is in a position to collect data from the transactions and processes that it performs on behalf of the enterprise 500 and use this data to perform Six Sigma Analysis since it is already collecting data from these processes and applications. Therefore, it is merely necessary to have the enterprise identify the critical transaction types and other data on which Six Sigma Analysis is to be performed and the IT provider can then provide systems that collect or mine this data from the data that is already collected and then perform Six Sigma Analysis on this critical data.

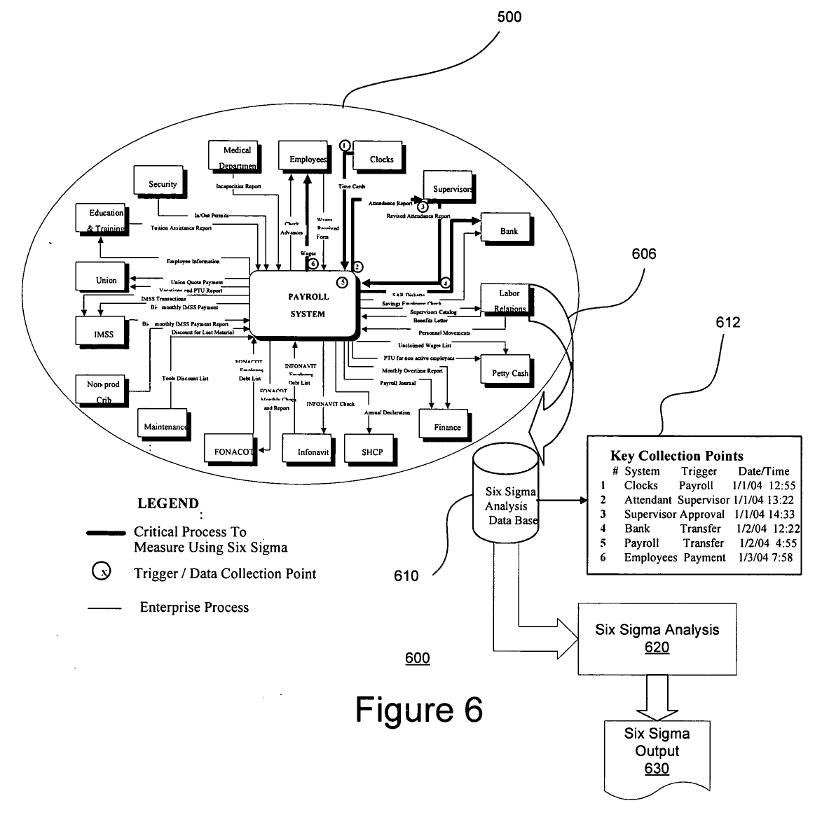

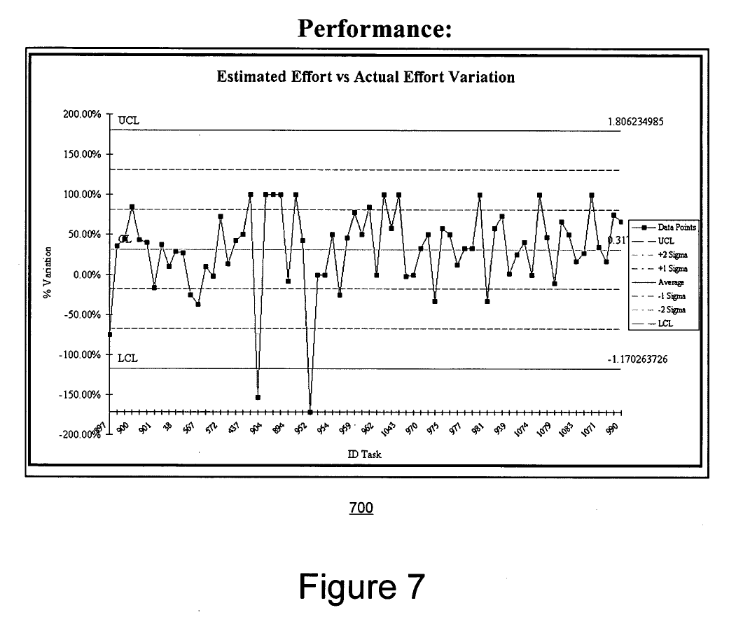

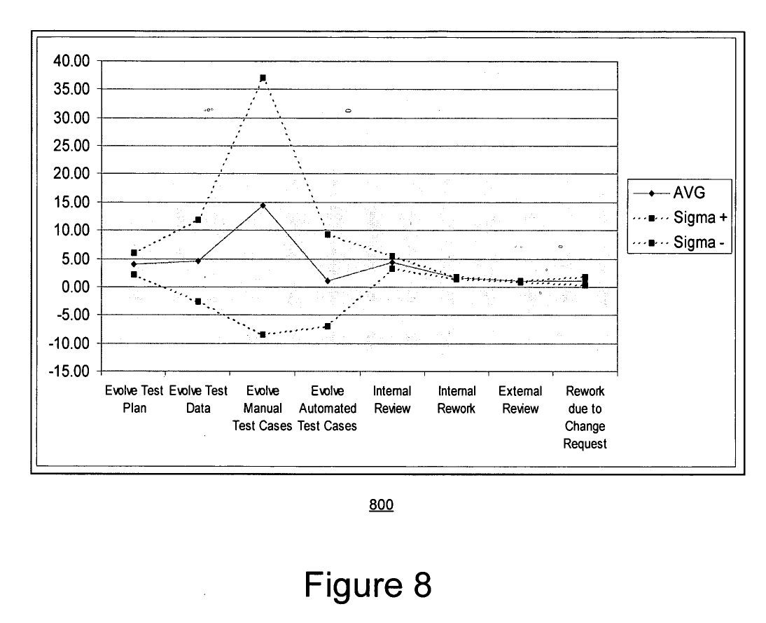

Thus, referring now to FIG. 6, a schematic diagram illustrating an exemplary system for collecting critical data and transferring this data to a Six Sigma database is depicted in accordance with one embodiment of the present invention. Key collection points 612, such as, for example, collection points \textcircled{1}-\textcircled{6}, are identified by the enterprise and the Six Sigma system 600 collects the data from the multitude of transactions performed in enterprise system 500 and sends 606 to Six Sigma database 610 for storage. Six Sigma Analysis Unit 620 utilizes the data stored in Six Sigma database 610 to perform Six Sigma Analysis and generates Six Sigma output 630 which may be utilized by the enterprise in order to make informed business decisions. Examples of output generated by a Six Sigma analysis are depicted in FIGS. 7 and 8 in accordance with one embodiment of the present invention.

Six Sigma techniques, when used with critical processes, results in cost savings for clients of an Information Technology and Services provider. The present invention provides modules and/or programming which may be included with an IT developed solution for a client that monitor the process and transactions submitted. In this way, application systems can report or identify the stability, process control and out of process specifications to critical processes supported by the application system developed for the customer. Providing this module or program which performs this activity for IT clients will enable IT provider clients to see how they are performing, improvements that are needed, and critical processes that are in need of change.

Although described herein primarily with reference to Six Sigma Analysis, the present method, system, and computer program product may be applied to any business statistical analysis and as such, the present invention is not limited to Six Sigma Analysis but may be applied to any business statistical analysis depending on the implementation desired by the user.

To aid the Patent Office, and any readers of any patent issued on this application in interpreting the claims appended hereto, it is noted that applicant does not intend any of the appended claims to invoke paragraph 6 of 35 U.S.C. § 112 as it exists on the date of filing unless the words “means for” are used in the particular claim. Furthermore, none of the description in the present application should be read as implying that any particular element, step, or function is an essential element which must be included in the claim scope: THE SCOPE OF THE PATENTED SUBJECT MATTER IS DEFINED ONLY BY THE ALLOWED CLAIMS. Thus, the extent of legal protection will be determined by the limitations recited in the allowed claims and their equivalents. Unless explicitly recited, other aspects of the present invention as described in this specification do not limit the scope of the claims.

As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of collecting data for business statistical analysis from an information technology provided solution, the method comprising:
determining business critical processes;
determining business critical collection points based on the identity of the business critical processes;
monitoring the business critical processes; and
collecting data at the business critical collection points.

2. The method as recited in claim 1, further comprising:
storing the collected data in a database.

3. The method as recited in claim 2, further comprising:
performing a business statistical analysis on the data stored in the database.

4. The method as recited in claim 3, further comprising:
generating an graphical output for use in making informed business decisions.

5. The method as recited in claim 1, wherein the business statistical analysis is Six Sigma Analysis.

6. A computer program product in a computer readable media for use in a data processing system for collecting data for business statistical analysis from an information technology provided solution, the computer program product comprising:
first instructions for determining business critical processes;
second instructions for determining business critical collection points based on the identity of the business critical processes;
third instructions for monitoring the business critical processes; and
fourth instructions for collecting data at the business critical collection points.

7. The computer program product as recited in claim 6, further comprising:
fifth instructions for storing the collected data in a database.

8. The computer program product as recited in claim 7, further comprising:
sixth instructions for performing a business statistical analysis on the data stored in the database.

9. The computer program product as recited in claim 8, further comprising:
Seventh instructions for generating an graphical output for use in making informed business decisions.

10. The computer program product as recited in claim 6, wherein the business statistical analysis is Six Sigma Analysis.

11. A system for collecting data for business statistical analysis from an information technology provided solution, the system comprising:
first means for determining business critical processes;
second means for determining business critical collection points based on the identity of the business critical processes;
third means for monitoring the business critical processes; and
fourth means for collecting data at the business critical collection points.

12. The system as recited in claim 11, further comprising:
fifth means for storing the collected data in a database.

13. The system as recited in claim 12, further comprising:
sixth means for performing a business statistical analysis on the data stored in the database.

14. The system as recited in claim 13, further comprising:
Seventh means for generating an graphical output for use in making informed business decisions.

15. The system as recited in claim 11, wherein the business statistical analysis is Six Sigma Analysis.
